(19) United States
(12) Patent Application Publication
(10) Pub. No.: US 2004/0145562 A1
(43) Pub. Date: Jul. 29, 2004

(54) Electrophoretic display and process for producing the same

(76) Inventor: Tomonari Horikiri, Sagamihara-shi (JP)

Correspondence Address: MORGAN & FINNEGAN, L.L.P., 345 PARK AVENUE, NEW YORK, NY, 10154, US

(21) Appl. No.: 10/696,176

(22) Filed: Oct. 28, 2003

(30) Foreign Application Priority Data
Oct. 28, 2002 (JP) 312566/2002(PAT.)

(51) Int. Cl. G09G 3/34

(52) U.S. Cl. 345/107

(57) ABSTRACT

An electrophoretic display includes a substrate, and at least one pixel disposed thereon. Each pixel includes electrophoretic particles and a dispersion medium or includes the electrophoretic particles, the dispersion medium and a color filter layer. At least one of the electrophoretic particles, the dispersion medium and the color filter layer constituting each pixel has a property of being colored a predetermined color by an external stimulus. One of the electrophoretic particles, the dispersion medium and the color filter layer is changeable into a colored member by the external stimulus.

### FIELD OF THE INVENTION AND RELATED ART

The present invention relates to an electrophoretic display for effecting display by causing electrophoretic particles to migrate in liquid, and a production process thereof.

In recent years, a liquid crystal display device has been generally used.

On the other hand, however, a reflection type display apparatus is expected from the viewpoints of low power consumption and reduction of burden imposed on eyes. As an embodiment thereof, there has been known an electrophoretic display capable of attaining a display effect by applying an electric field to a liquid in which electrophoretic particles are dispersed to move the electrophoretic particles based on an electrophoresis phenomenon. Such an apparatus is constituted by the electrophoretic display and drive means therefor. The electrophoretic display is generally of such a type that an electrophoretic display medium is disposed between a pair of substrates at least one of which is transparent, and an electric field is applied to the display medium through an electrode provided to either one or both of the substrates to change a distribution of colored particles, thus achieving a display effect.

The electrophoretic display medium principally comprises a liquid, so that it is necessary to prevent flowing out or volatilization of the display medium from a display panel. As one of means for preventing such flowing out or volatilization, there is a method in which the electrophoretic display medium is encapsulated in a microcapsule.

Such a conventionally known microcapsules for the electrophoretic display has principally been formed through any of an interfacial polymerization, an in situ polymerization, and phase separation (coacervation), and the resultant microcapsule is mixed with a binder resin to provide a resin composition. The resin composition is generally applied onto a substrate by roll coating, roll laminating, screen printing, spray coating, or the like, thus preparing a display panel.

In order to apply such an electrophoretic display to a multi-color display device, colored electrophoretic particles and/or a dispersion medium colored a color different from that of the colored electrophoretic particles has ordinarily been used. Alternatively, it is also possible to prepare a multi-color display apparatus by providing a color filter, similar to that used for the liquid crystal display apparatus, to the electrophoretic display.

However, the above-described preparation or arrangement method of microcapsule is required to form microcapsules of types of colors intended to be disposed, so that a production process become complicate at the time of preparing a multi-color display panel.

In view of this problem, Japanese Laid-Open Patent Application No. 2000-035769 discloses a method in which microcapsules are arranged one by one at a predetermined position by utilizing an ink jet scheme.

According to the method, microcapsules are supplied by the ink jet method. However, the method is liable to be technically accompanied with a difficulty as a definition or resolution of the resultant display panel is increased. Further, in the case of a large-sized high definition display panel, it is necessary to arrange a great number of microcapsules at a predetermined position, so that a time required for preparing the display panel becomes longer in such a method wherein microcapsules are supplied one by one through a nozzle. As a result, there is a possibility that a large problem on production arises. Further, in the case of using an electrophoretic display provided with a color filter layer, it is necessary to successively adjust positions of electrodes for driving microcapsules, microcapsules to be actuated and pixels of the color filters. As a result, there is a possibility that the electrophoretic display is accompanied with a difficulty in production process.

### SUMMARY OF THE INVENTION

An object of the present invention is to provide a process for producing an electrophoretic display excellent in display qualities through simple steps.

Another object of the present invention is to provide such an electrophoretic display.

According to the present invention, there is provided an electrophoretic display, comprising:

a substrate, and

at least one pixel disposed thereon comprising electrophoretic particles and a dispersion medium or comprising the electrophoretic particles, the dispersion medium and a color filter layer,

wherein at least one of the electrophoretic particles, the dispersion medium and the color filter layer constituting each pixel has a property of being colored a predetermined color by an external stimulus and the one of the electrophoretic particles, the dispersion medium and the color filter layer is changeable into a colored member by the external stimulus.

According to the present invention, there is also provided a process for producing an electrophoretic display of the type wherein at least one pixel comprising electrophoretic particles and a dispersion medium and optionally a color filter layer is disposed on a substrate, the process comprising:

a step of providing a member, to be colored a predetermined color by an external stimulus, as at least a part of members constituting the at least one pixel, and

a step of coloring the member to be colored by applying the external stimulus to the member.

By using the production process of electrophoretic display according to the present invention, it is possible to simply effect color arrangement at a predetermined position. As a result, it becomes possible to perform a simple positional alignment of a device particularly using microcapsules, which has been conventionally difficult, and production steps of the device can be facilitated

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic view for illustrating an embodiment of the process for producing an electrophoretic display according to the present invention.

FIGS. 2-5 are respectively a schematic view showing an embodiment of the electrophoretic display according to the present invention.

### DETAILED DESCRIPTION OF THE PREFERRED EMBODIMENT

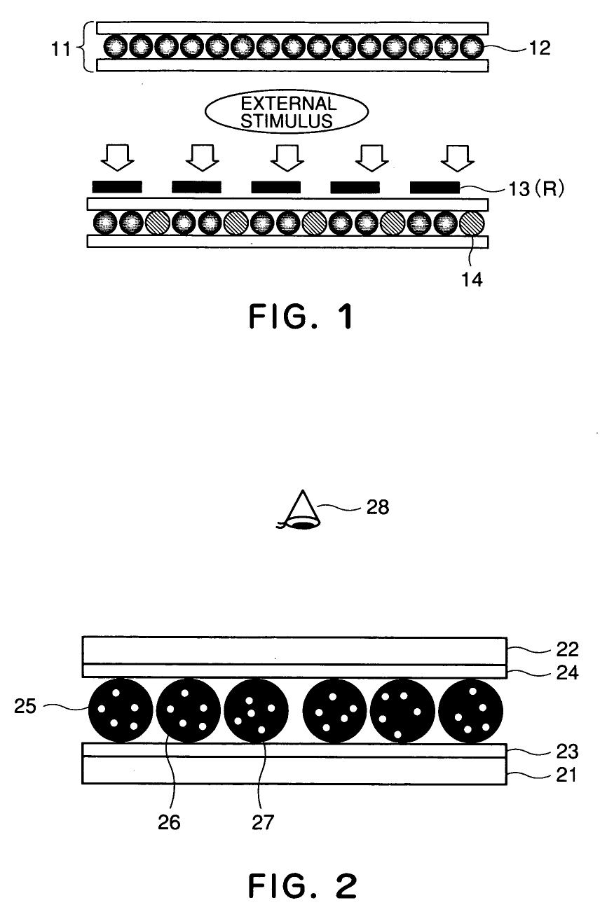

Hereinbelow, the present invention will be described more specifically with reference to FIGS. 1-5.

In the present invention, the colored member is at least one of the electrophoretic particles, the dispersion medium, and the color filter layer. The colored member may contain a dye which is colored by at least the external stimulus. The dye may be encapsulated in a microcapsule. The dye may have a property of assuming a plurality of different colors by at least one species of external stimulus.

The production process of the present invention may include a step of hermetically sealing at least the electrophoretic particles and the dispersion medium, and a step of coloring at least one of the above-mentioned three members a plurality of colors by applying at least one species of external stimulus to the member(s).

The production process of the present invention may include such a hermetically sealing step wherein the electrophoretic particles and the dispersion medium are confined or sealed in at least one space which is defined by at least one substrate and at least one partition wall disposed thereon and is located on the substrate.

The production process of the present invention may include such a hermetically sealing step wherein the electrophoretic particles and the dispersion medium are encapsulated in each microcapsule or confined or sealed in a space defined by the partition wall formed between oppositely disposed two substrates.

The production process of the present invention may include such a coloring step wherein the member to be colored is colored by applying the external stimulus to only an arbitrarily selected area. Further, the process may also include a step of providing a shielding member between an external stimulus generating source and the electrophoretic display so as to permit selective irradiation only in a desired area.

The production process of the present invention may include the use of energy (radiation) as the external stimulus which is particularly selected from the group consisting of thermal energy, light energy, electron ray, γ ray, and X ray.

In the electrophoretic display according to the present invention, at least one of members constituting a pixel is required to be capable of being colored a predetermined color by an external stimulus. Herein, members constituting the pixel are referred to as “optical modulation members” since they have a function of coloring incident light and reflected light. The optical modulation members are constituted by a combination of the electrophoretic particles and the dispersion medium Or a combination of the electrophoretic particles, the dispersion medium, and the color filter layer, and are capable of providing color information. In the present invention, at least one of these optical modulation members is required to be colored but a plurality of these optical modulation members may preferably be colored at the same time since the resultant color becomes clear.

In the present invention, a coloring method of coloring at least one of the optical modulation members to be colored a predetermined color by the external stimulus other than a drive voltage (application) includes the following cases (1)-(3):

(1) the case wherein the optical modulation member is colored a predetermined color by a first external stimulus but is not colored even by another external stimulus,

(2) the case where the optical modulation member is colored a predetermined color by a first external stimulus and is returned to the original color (before the first external stimulus application) by a second external stimulus, and

(3) the case where the optical modulation member is colored a predetermined color by a first external stimulus and then is further colored an arbitrary color by subsequent external stimulus (stimuli).

As described in the above three cases (1)-(3), from the present invention, the case where the optical modulation member is colored an arbitrary color by a change in drive voltage is excluded. Further, in the present invention, the coloring refers to a change in color from a certain color to another color, and includes the case of color fading or decoloring into a colorless state or development of color from the colorless state.

In the present invention, the electrophoretic display may be prepared by preparing a device structure including an optical modulation member to be colored by an external stimulus and a space in which at least electrophoretic particles and a dispersion medium are hermetically sealed or confined, and coloring a predetermined pixel a predetermined color by applying thereto at least one species of external stimulus.

The production process of the electrophoretic display according to the present invention may preferably include the following two steps.

(Step 1)

This is a step of spatially hermetically sealing (confining) a dispersion medium containing electrophoretic particles. This step may be one wherein the electrophoretic particles and the dispersion medium are hermetically sealed in such a space that is defined by at least one substrate and at least one (partition) wall disposed on the surface of the substrate. In this case, it is possible to use any means for defining or partitioning the dispersion medium. Such a means is not particularly limited but may preferably be microcapsule(s) or a partition wall (spacer) for holding a pair of substrates at a certain gap therebetween.

(Step 2)

The device prepared through Step 1 is a monochrome electrophoretic display. Step 2 is a step of applying at least one species of external stimulus to the electrophoretic display to cause at least one optical modulation member to develop or be colored at least one species of color.

(Embodiment 1)

FIG. 1 illustrates an embodiment of the electrophoretic display of the present invention, wherein the optical modulation member is the dispersion medium.

As shown in FIG. 1, an electrophoretic display 11 in which microcapsules 12 each comprising electrophoretic particles and a dispersion medium capable of being colored red (R), green (G) and blue (B) by an external stimulus are hermetically sealed is provided with a shielding member (mask) 13(R) at a portion which is not to be colored, followed by irradiation with an external stimulus for coloring the dispersion medium red. As a result, a portion (microcapsule 14) irradiated with the external stimulus is colored red. Then, the mask is disposed at another pixel position and external stimulus irradiation for coloring the dispersion medium green is performed to color the dispersion medium blue. As described above, by appropriately performing a step of applying an external stimulus so as to color a predetermined position a desired color.

The external stimulus employed in the present invention may include energy beam which may preferably selected from the group consisting of thermal energy, light energy, electron ray, γ ray and X ray. These energy beams are not particularly restricted so long as they have species and intensity capable of coloring the optical modulation member to be colored. It is also possible to successively apply two or more species of energy beams or apply their beams at the same time. Further, it is possible to apply an external stimulus accompanied with energy conversion from light energy to thermal energy through an energy conversion portion.

In order to color the optical modulation member a predetermined color, a colorant (tinting colorant) may preferably be used. The tinting colorant is not particularly limited so long as it can assume a predetermined color.

Examples of the tinting colorant may include those causing color development/color fading or decoloring by reaction with developer/decolarizer containing acid, alkali, etc.; those causing a structural change of a specific substituent in their molecular structure to change their absorption wavelength; and those causing a change in reflectance or transmittance of light by phase change. The tinting colorant may also include those used in the presence of developer or decolorizer, and may generally include dyes and pigments.

Further, these tinting colorants may be enclosed by a capsulation (microencapsulation) means. By doing so, it is possible to effect coloring by separately encapsulating and isolating colorants which are colored in the presence of developer, decolorizer, or the like, and breaking the (micro-)capsules by external energy to cause these colorants to contact each other.

In the case where the tinting colorants adversely affect display characteristics, in the present invention, it is possible to encapsulate and isolate the tinting colorants so that they do not adversely affect display characteristics or also possible to use encapsulated tinting colorants as electrophoretic particles as described later.

Specific examples of the colorant to be colored with the developer or the decolorizer may include: phenyl-phthalide compounds represented by 3,3-bis(p-dimethylaminophenyl)-6-dimethylaminophthalide (CVL (crystal violet lactone)), malachite green lactone, and 3,3-bis(p-dimethylaminophenyl)-6-diethylaminophthalide; fluoran compounds represented by 3-diethylamino-6-methyl-7-anilinofluoran, 2-(N-p-tolyl-N-ethylamino)-6-methyl-7-anilinofluoran, 3-N-methyl-N-amylamino-6-methyl-7-anilinofluoran, 3-diethylamino-7-(o-chloroanilino)-fluoran, and 3-dibutylamino-7-(o-chloroanilino)-fluoran; spirane compounds represented by 6(-bromo-3′-methoxy-benzoindolino-pyrylospirane; phenothiazine represented by BLMB (benzyl leucomethylene blue); carbazoli blue; pyridyli blue; triphenylmethane compounds; choromenoindole compounds; 3-(4-diethylamino-2-ethoxyphenyl)-3-(1-ethyl-2-methylindole-3-yl)-4-azaphthalide; 3-(4-diethylaminophenyl)-3-(1-ethyl-2-methylindole-3-yl)phthalide; 3-diethylamino-7-chloroanilinofluorane; 3-diethylamino-7,8-benzofluorane; 3,3-bis(1-n-butyl-2-methylindole-3-yl)phthalide; 3,6-dimethylethoxyfluorane; 3-diethylamino-6-methoxy-7-aminofluorane; 2-(2-chloroanilino)-6-dibutylaminofluorane; crystal violet carbinol; malachite green carbinol; N-(2,3-dichlorophenyl)leucoauramine; N-benzoylauramine; rhoramine B lactam; N-acetylauramine, N-phenylauramine; 2-(phenyliminoethanedylidene)-3,3-dimethylindoline; 3,3-trimethylindolinobehzosppiropyran; 8′-methoxy-N,3,3-trimethylindolinobenzospiropyran; phenylhydrazid-γ-lactam; 3-amino-5-methylfluorane; leuco dyes.

These colorants may be used singly or in mixture of two or more species.

In the present invention, after colored a predetermined color by a first external stimulus with the above-mentioned colorants, the optical modulation member may be returned to an original color by another external stimulus.

Specific examples of the developer may include: ethyl p-hydroxybenzoate, butyl p-hydroxybenzoate, benzyl p-hydroxybenzoate, 4,4-isopropylidenediphenol, 4,4-isopropylidenebis(2-chlorophenol), 4,4-isopropylidene-bis(2,6-dimethylphenol), 4-hydroxyphenyl-2′-hydroxyphenylsulfone, catechol, resorcin, thymol, phloroglucine, phloroglucine carbonate, N,N-diphenylthiourea, N-p-butylphenyl-N′-phenylthiourea, benzoic acid, 4-hydroxy-4′-chlorodiphenyl sulfone, bis(4-hydroxyphenyl)sulfide, o-sulfophthalimide, 5-octyl-o-sulfophthalimide, phenol and phenol derivative, phenol derivative metal salt, carboxylic acid metal salt, salicylic acid and salicyclic acid metal salt, benzophenone derivative, sulfonic acids, sulfonates, phosphoric acids, phosphoric metal salts, acid phosphoric esters, acid phosphoric ester metal salts, phosphorous acids, phosphorous acid metal salts, and zinc halide. These may be used alone or in combination of two or more species.

Specific examples of the decolorizer may include: piperazine compounds represented by N-methyl-N′-phenylacetyl piperazine, N-phenyl-N′-phenylacetyl piperazine, N-lauryl-N′-phenylacetyl piperazine, N-benzyl-N′-phenylacetyl piperazine, and N-phenyl-N′-p-chlorobenzoyl piperazine, and N-phenyl-N′-p-chlorobehzoyl piperazine; diamide compounds represented by N,N,N′,N′-tetrabutylsuccindiamide, N,N,N′,N′-tetrastearylsuccindiamide, N,N,N′,N′-tetraphenyladipicdiamide, N,N,N′,N′-tetrabutyladipicdiamide, and N,N-dicyclohexyl-N′,N′-dimethylsuccinamide; adipoyldihyperidone, succinyl-di-3-chloro-ε-caprolactam, N,N′-terephthaloylbis-piperadine, N,N′-isophthaloyl piperadine, N,N′-isophthaloylbismorphorine, N,N′-phthaloylbiscaprolactam, N,N′-terephthaloylbis-dibutylamine, N,N′-isophthaloyl-dicyclohexylamine, N,N′-isophthaloylbis-dibenzoylaminoethylamine, N,N-terephthaloylbis(3-methylpiperidine), N,N′,N″-tribenzoyl-diethylenetriamine, N,N′-isophthaloyldi(N-cyclohexyl-N-methylamide), ethylenediaminetetraacetic acid tetraanilide, and ethylenediaminetetraacetic acid tetracyclohexylamide. These may be used singly or mixture of at least two species.

Further, it is possible to add an additive to the colorant, such as a sensitizer, a stabilizer, or the like, as desired. The sensitizer is used for changing a sensitivity of the tinting colorant to the external stimulus. A material for the sensitizer is not particularly restricted. Specific examples there of may include: amides, such as palmitic acid amide, stearic acid amide, behenic acid amide, and 12-bisoctadecanoylaminoethane; urea derivatives, such as octadecyl urea; naphthol derivatives, such as 2-benzyloxynaphthalene, and 1-benzyloxy-4-methoxynaphthalene; biphenyl derivatives, such as p-benzylbiphenyl, 4-aryloxybiphenyl, and m-terphenyl; polyether compounds, such as 1,2-diphenoxyethane, 2,2′-bis(4-methoxyphenoxy)diethyl ether, bis(4-methoxyphenyl)ether; carbonic or oxalic acid derivatives, such as diphenylcarbonate, dibenzyl oxalate, and bis(p-methylbenzyl)oxalate. The kinds and amounts of these additives are not particularly limited since they vary depending on the tinting colorant selected.

Further, in the present invention, it is generally effective to use a adding colorant. In addition, it is possible to color the tinting colorant by adding a substance which is unstable against the external stimulus in a substance which is stable against the external stimulus and activating the unstable substance to cause chemical reaction or physical connection with the tinting colorant. The tinting colorant used in the present invention may also include a light absorbing colorant including near infrared absorbing colorant for use in optical disk etc., a colorant for laser, and a photosensitive colorant used for a copying machine or photography.

As the colorant (material) for changing reflectance or transmittance of light by, e.g., phase change, it is possible to use a phase separation polymer or a liquid crystal compound such that a temperature difference create by gradually or abruptly cooling the polymer or compound after applying heat as the external stimulus to it, or a difference in electric or magnetic field cared between before and after heating, causes a change in reflectance or transmittance of light.

Next, examples of the case where the optical modulation member is the electrophoretic particles may include the case where the electrophoretic particles per se are a tinting colorant and the case of the electrophoretic particles being contained in a supporting medium. In the latter case, the tinting colorant may be at least dispersed in the supporting medium. For example, if the tinting colorant is a dye, the supporting medium may preferably be dyed, and if the tinting colorant is a pigment, the pigment may preferably be dispersed in the supporting medium. The material for the supporting medium is not particularly limited as long as the tinting colorant can be subjected to dyeing or dispersion to effect electrophoretic display. The supporting medium per se may have a color which is not colored by the external stimulus.

In the case where the tinting colorant affects the display characteristics irrespective of before or after the external stimulus irradiation, it is necessary to take some measured. More specifically, an additive which counteracts the influence of the tinting colorant may be added in the electrophoretic particles or the dispersion medium, or the electrophoretic particles may be coated with a substance which does not adversely affect the display characteristics. Alternatively, as described above, the tinting colorant is encapsulated in capsules, and the capsule per se may be used as the electrophoretic particles. In that case, it is also possible to encapsulate a solvent for dissolving the tinting colorant in the capsules.

The case where the optical modulation member is the dispersion medium may include the dispersion medium in which at least the tinting colorant is dispersed or the dispersion medium which is only consisting of liquid tinting colorant. In the case where the tinting colorant is the dye, the dye may preferably be dissolved in the dispersion medium. Further, it is necessary to take some measures in the case where the tinting colorant adversely affects the display characteristics. More specifically, it is possible to add an additive which counteracts the influence of the tinting colorant. Alternatively, an additive for improving the dispersibility may be added in the tinting colorant, or encapsulated in or coated on the capsules.

Further, it is possible to improve a sensitivity of the tinting colorant to the external stimulus by adding an assistant such as a sensitizing colorant or an infrared absorption colorant. However, it is important for the assistant not to adversely affect the display characteristics. The concentration of the tinting colorant may appropriately be selected on the basis of, e.g., color development performance and ease of coloring of the tinting colorant.

In the case where the electrophoretic particles and the dispersion medium are not used as the optical modulation member, the following materials can be used.

As the dispersion medium, it is possible to use known liquids which are high insulative, colorless and transparent. Further, it is possible to further add a charge control agent, a dispersing agent, a lubricant, a stabilizer, or the like, as desired.

In order to color the dispersion medium, it is possible to use an oil soluble dye. Examples thereof may preferably include azo dyes, anthraquinone dye, quinoline dyes, nitro dyes, nitroso dyes, phenoline dyes, phthalocyanine dyes, metal complex salt dyes, naphol dyes, benzoquinone dyes, cyanine dyes, indigo dyes, quinorimine dyes, etc. These may be used in combination.

Specific examples of oil soluble dyes may include Barifast Yellow (1101, 1105, 3108, 4120), Oil Yellow (105, 107, 129, 3G, GGS), Barifast Red (1306, 1355, 2303, 3304 3306, 3320), Oil Pink 312, Oil Scarlet 308, Oil Violet 730 Barifast Blue (151, 603, 1605, 1607, 2606, 2610, 3405), Oil Blue (2N, BOS,

613), Macrolex Blue RR, Sumiplast Green G, Oil Green (502, G), etc. These oil soluble dyes may preferably be used in a concentration of 0.3-3.5 wt. %.

As the electrophoretic particles, known materials can be used. Examples thereof may include an organic material such as polymer fine particles, an inorganic material such as pigments, mixtures of these materials, and organic or inorganic hybrid material. These materials are not particularly restricted but may preferably be pigments of white, black, red (R), green (G), blue (B), yellow (Y), magenta (M), and cyan (C). As white particles, it is possible to use those of titanium oxide, aluminum oxide, zinc oxide, lead oxide tin oxide, magnesium sulfate, silica, etc. As black particles, it is possible to use those of carbon black, aniline black, manganese ferrite black, cobalt ferrite black, etc. Examples of the respective primary color pigments may include red pigments such as cadmium red, quinacridone red, lake red, brilliant carmine, and madder lake; green pigments, such as diamond green lake, phthalocyanine green, and pigment green B; blue pigments, such as cobalt blue, victoria blue, phthalocyanine blue, fast key blue; yellow pigments, such as hansa yellow, cadmium yellow, fast yellow, disazo yellow, titane yellow, yellow (iron) oxide, and chrome yellow. Further, as the electrophoretic particles, it is possible to use particles surface-coated with known resins or charge control materials.

(Embodiment 2)

FIG. 2 is a sectional view showing an embodiment of the electrophoretic display according to the present invention.

Referring to FIG. 2, the electrophoretic display includes a pair of substrates 21 and 22, a first electrode 23 and a second electrode 24 formed on the substrates 21 and 22, respectively, and microcapsules 25 sandwiched between the first and second electrodes 23 and 24. The microcapsule 25 includes therein a dispersion medium 26 and electrophoretic particles 27. The electrophoretic display is viewed from the substrate 22 side by a viewer 28.

The electrophoretic display is driven in the following manner.

In this embodiment, the dispersion medium 26 is black and the electrophoretic particles 27 are positively charged and assume white. When a positive (+) bias voltage is applied to the first electrode 23 in a state that the second electrode 24 is grounded as a common electrode, the electrophoretic particles 27 are concentrated at the second electrode 24, so that the electrophoretic display assumes white being the color of the electrophoretic particles when viewed from the display surface side. Then, when a negative (−) bias voltage is applied to the first electrode 23, the electrophoretic particles are moved from the second electrode 24 to the first electrode 23, so that the electrophoretic display assumes black being the color of the dispersion medium 26. Thus, the coloring at the display surface is under the domination of distribution of the electrophoretic particles 27 in a vertical direction.

In this embodiment, the pair of substrates are employed but a single substrate may also be used so long as the microcapsules are disposed on the substrate and fixed at a predetermined position by a certain means. However, the microcapsules may preferably be sandwiched between the pair of substrates.

The electrodes may be disposed on the substrate surface(s) so that a plurality of electrodes (preferably the pair of electrodes as in this embodiment) can apply an electric field to the microcapsules to allow a predetermined display. Further, as in this embodiment, one of the electrodes may be a common electrode. The first electrode 23 may be formed in pixel electrodes so that they independently apply a desired electric field to an associated microcapsule. In such a case, each pixel electrode is provided with a switching device, such as TFT (thin film transistor), so as to apply a predetermined electric field to each (associated) microcapsule.

In each pixel, the electrodes are not particularly limited so long as they include at least a pair of electrodes which are disposed so as to apply an electric field to the microcapsule(s). Further, the pixel may be mutually partitioned by, e.g., a black matrix.

Each of the microcapsules shown in FIG. 2 includes at least one species of color electrophoretic particles and a dispersion medium different in color from the electrophoretic particles. The electrophoretic display (display surface) is colored by applying an external stimulus to the electrophoretic particles and/or the dispersion medium. The color and the kind of the electrophoretic particles are not particularly restricted but may preferably include only white, only black, white and black in mixture, a color arbitrarily selected from the primary colors of red (R), green (G) and blue (B), and a color arbitrarily selected from yellow (Y), magenta (M), cyan (C) and black (K). In the case where two species of different particles are used in mixture, these particles may preferably have charging performances different from each other. The color of the dispersion medium is also not particularly restricted as long as it is different from the color of the electrophoretic particles.

The electrophoretic particles may preferably have a particle size of 0.01-10 μm, more preferably 0.1-6 μm.

The electrophoretic particles may preferably be contained in the microcapsule in an amount of 3-30 wt. % per the dispersion medium.

Further, the microcapsule may have a particle size of 10-200 μm, preferably 10-100 μm, more preferably 20-80 μm.

At least one of microcapsules may be disposed in a display area for one pixel defined or determined by the electrode arrangement. Further, one microcapsule may be extended over two or more pixels but may preferably be disposed within one pixel.

In order to prevent positional deviation at the microcapsules disposed on the substrate, the microcapsules may be fixed on the substrate by impregnating or filling a space between the microcapsules with a binder resin. The binder resin may include a light-transmissive water soluble polymer, such as polyvinyl alcohol, polyurethane, acrylic resin or silicone resin. It is also possible to add a colorant (including the tinting colorant).

(Embodiment 3)

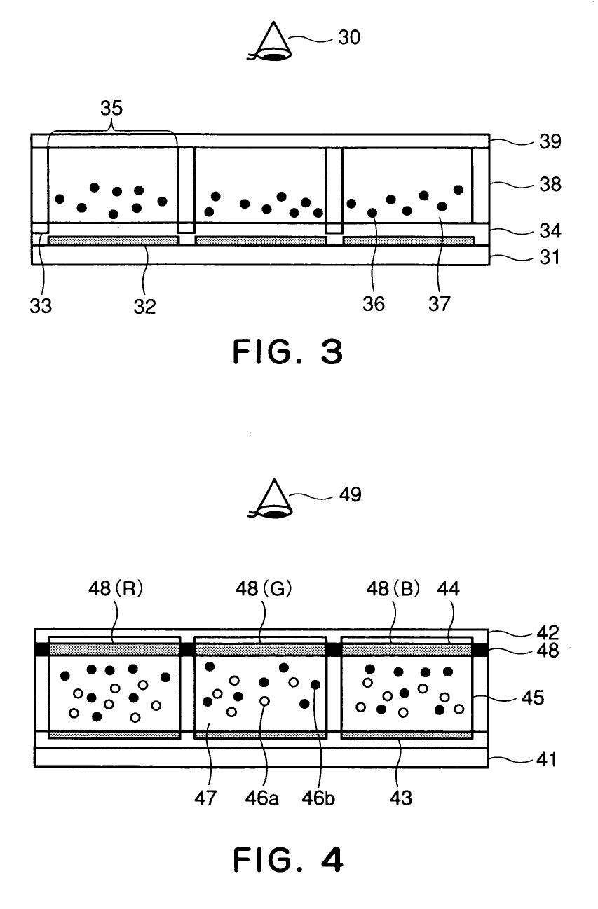

FIG. 3 is a sectional view showing an embodiment of the electrophoretic display of the present invention.

The electrophoretic display include a pair of substrates 31 and 39, a first electrode 32 formed on the substrate 21, an insulating layer 34 disposed on the first electrode 32, a second electrode 33 disposed on the insulating layer 34, a partition wall (spacer) 38 disposed between the pair of substrates 31 and 39, a space (cell) 35 which is defined by the partition wall 38, the insulating layer 34 and the substrate 39 and includes electrophoretic particles 36 and a dispersion medium 37 which are hermetically sealed therein. The electrophoretic display is viewed from the substrate 39 side by a viewer 30.

In this embodiment, the dispersion medium 37 is colorless, the electrophoretic particles 36 are positively charged and assume black, and insulating layer assumes white. When a negative (−) bias voltage is applied to the first electrode 32 in a state that the second electrode 33 is grounded as a common electrode, the electrophoretic particles 36 are concentrated at the first electrode 32, so that the display surface assumes black. Then, when a positive (+) bias voltage is applied to the first electrode 32, the electrophoretic particles are moved from the first electrode 32 to the second electrode 33, so that the insulating layer portion corresponding to the first electrode is viewed by the viewer 30. As a result, the display surface assumes black. Thus, the contrast at the display surface is under the domination of a change in distribution of the electrophoretic particles 36 in a planar direction (In-Plane mode). The contrast varies largely depending on an opening rate and a scattering efficiency of the insulating layer 34 (first electrode 32).

(Embodiment 4)

FIG. 4 is a sectional view showing an embodiment of the electrophoretic display of the present invention.

The electrophoretic display include a pair of substrates 41 and 42, a first electrode 42 and a second electrode 44 disposed on the substrate 41 and 42, respectively, a partition wall (spacer) disposed between the pair of substrates, a space (cell) 45 which is defined by the partition wall, the first and second electrodes 43 and 44 and includes white electrophoretic particles 46, black electrophoretic particles 46b and a dispersion medium 47 which are hermetically sealed therein. The electrophoretic display is viewed from the substrate 42 side by a viewer 49.

The second electrode 44 is provided with a color filter layer 48 including regions of red (R), green (G) and blue (B) corresponding to respective pixel regions.

In this embodiment, the dispersion medium 47 is colorless, the white electrophoretic particles 46a are positively charged, and the black electrophoretic particles 46b are negatively charged. When a positive (+) bias voltage is applied to the first electrode 43 in a state that the second electrode 44 is grounded as a common electrode, the white and black electrophoretic particles 46a and 46b are concentrated at the second and first electrodes 44 and 43, respectively, so that the electrophoretic display assumes the color of the color filter corresponding to the associated pixel when viewed from the display surface side. Then, when a negative (−) bias voltage is applied to the first electrode 43, the white electrophoretic particles 46a are moved from the second electrode 44 to the first electrode 43 and the black electrophoretic particles 46b are moved from the first electrode 43 to the second electrode 44, so that the display surface assumes black.

The substrates, electrophoretic particles, dispersion medium, cells and partition walls are identical to those used in Embodiment 3 (FIG. 3).

The color filter layer 48 includes color filter segments each selected arbitrarily corresponding to an associated pixel. The colors of the color filter segments may preferably be selected from three color system of red (R), green G) and blue (B) (as in this embodiment) or four color system of yellow (Y), magenta (M), cyan (C) and black (K). Between adjacent color filter segments, it is possible to form, e.g., a black matrix. Further, in this embodiment, the color filter layer is formed on the substrate 42 side (viewer side) but its position is not particularly limited. It is also possible to dispose the color filter layer on the substrate 41 side (the first electrode 43 side).

In this embodiment, the color filter layer has a property of being colored by an external stimulus and contains at least the above-mentioned tinting colorant. Each of the color filter segments (48(R), 48(G), 48(B)) may be formed in a layer of an associated tinting colorant or a mixture of two or more tinting colorants capable of providing a predetermined color. Such a layer may preferably be formed of the tinting colorant alone but a binder or a surfactant may be added. The tinting colorant may preferably be well dissolved or dispersed in the binder or the surfactant, and these additives may preferably have a high transparency to energy beam to be applied.

(Embodiment 5)

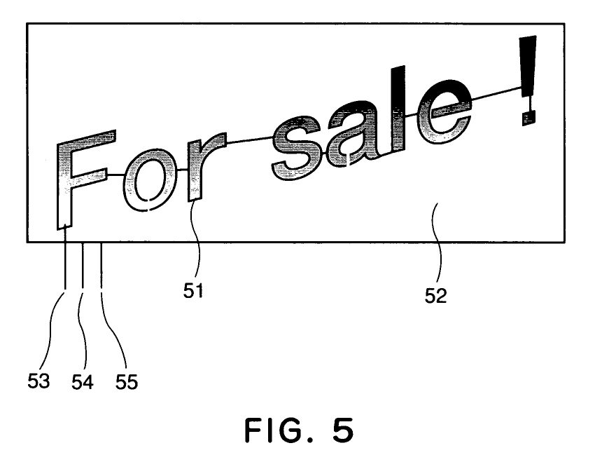

FIG. 5 shows an embodiment of the electrophoretic display of the present invention.

In this embodiment, referring to FIG. 5, an electrode is divided into two portions consisting of a character portion 51 and a non-character portion 52 which can be independently driven for display. The electrode includes a display electrode 53 for the character (display) portion, a display electrode 54 for the non-character (display) portion, and a common electrode 55. In Embodiments 2-4 (FIGS. 2-4), the pixel electrodes capable of independently applying desired electric field to each microcapsule or cell are employed. On the other hand, in this embodiment, the character portion and the non-character portion are respectively constituted by a plurality of microcapsules or cells as one pixel and are respectively supplied with a voltage. Further, it is also possible to provide arrangement of colors so that color gradation or multi-color display can be effected on one electrode as in the character portion. This can be realized by effecting mask exposure of the optical modulation member to be colored by the external stimulus so as to provide a desired arrangement of colors. As described above, separate (independent) drive of the character portion and the non-character portion is useful for providing a display apparatus for advertising and general publication medium or POP (Point of Purchase advertising).

Hereinbelow, the production process of the electrophoretic display in this embodiment will be described.

First, that using microcapsules will be explained.

An electrode is formed on a substrate. A material for the electrode is appropriately selected from patternable electroconductive materials. As the substrate, it is possible to use any member as long as it can support the electrophoretic display. Examples of a material for the substrate may include known glass or plastics such as PET (polyethylene terephthalate). Further, it is also possible to use a substrate improved in liquid permeability by coating the surface of a light weight porous ceramic substrate with a plastic material or a substrate improved in solvent resistance by coating the surface of a plastic film having a poor solvent resistance with a ceramic material.

A material for the electrode as an electric field may be appropriately be selected from known electrode materials.

On the electrode, an insulating layer of an insulating material is formed. The insulating material may preferably be formed in a thin film and less cause pin holes, specifically be a resin, such as acrylic resin or polycarbonate resin.

In the case of the In-plane type driving method, another electrode may be formed within or at the surface of the insulating layer. Further, it is also possible to form a color filter layer at the surface of the substrate, within the insulating layer, or at the surface of the insulating layer.

(Microcapsule Preparation Method)

Microcapsules can be prepared through a known process. More specifically, after constitutional material principally including a dispersion medium, electrophoretic particles, a coating substrate for forming a capsule wall, a surfactant, and so on are added, a known process such as interfacial polymerization, in situ polymerization, or phase separation process (coacervation process) is effected. As the surfactant, a polymeric surfactant may preferably be used. For example, those of styrene-maleic anhydride type or ethylene-maleic anhydride type, may be used in a concentration of 1-10 wt. %.

Then, the thus prepared microcapsules is spread on the substrate by, using e.g., a doctor blade.

When the microcapsules are disposed at a desired position, an unevenness pattern is formed in advance at a predetermined position on the substrate and the microcapsules may be disposed in the unevenness pattern.

The microcapsules may be spread on the substrate after being dispersed in liquid.

The layer of microcapsules disposed on the substrate is finally covered and sealed with another substrate after positional alignment, as desired. In this case, the two substrates may be pressed to seal the microcapsules so that a spacing between the microcapsules can be minimized.

The substrate used for sealing may be identical to the above-described substrate, and may be provided with an electrode thereon. This electrode may be patterned for controlling the respective pixels.

During the above steps, the tinting colorant is contained in at least one of the electrophoretic particles, the dispersion medium and the color filter layer at the time of preparing the microcapsules for the electrophoretic particles and the dispersion medium and at the time of preparing the color filter layer for the color filter layer. In this case, it is necessary to select the tinting colorant to be used so as to color it by the external stimulus in a subsequent step.

According to the above-described production process, it becomes possible to encapsulate the electrophoretic particles and the dispersion medium in each microcapsule.

(Cell Preparation Method Using Partition Wall)

Preparation of the substrate and the electrodes is performed in the same manner as in the production process of the electrophoretic display using the microcapsules.

On the substrate, a partition wall of a resin (polymer) is formed in a predetermined pattern through any method including one wherein exposure and wet development are performed after a photosensitive resin is applied onto the substrate, and one wherein a separately prepared partition wall is adhered to the substrate. The partition wall may be formed on the other substrate by, e.g., molding.

Then, the electrophoretic particles and the dispersion medium are filled in a space defined by the partition wall and the substrate, and a bonding layer is formed at a bonding surface to be bonded to the other substrate. Thereafter, the structure is covered and sealed with the other substrate, followed by positional alignment as desired.

During the above steps, the tinting colorant is contained in at least one of the electrophoretic particles, the dispersion medium and the color filter layer at the time of preparing the microcapsules for the electrophoretic particles and the dispersion medium and at the time of preparing the color filter layer for the color filter layer. In this case, it is necessary to select the tinting colorant to be used so as to color it by the external stimulus in a subsequent step.

According to the above-described production process, it becomes possible to hermetically seal the electrophoretic particles and the dispersion medium in each cell.

(Coloring Step)

A step of coloring the optical modulation member at least one species of color by applying the external stimulus to the substrate (display) surface.

The method of applying the external stimulus (irradiation method) may be divided into (1) a method of irradiating the entire substrate surface with the external stimulus at the same time and (2) a method of sequentially irradiating a predetermined area of the substrate surface with the external stimulus.

The method (1) of simultaneously irradiating the entire substrate surface is a simple process for display panels for displaying two colors of white and black or three colors of white, black and colorless. In this case, an exposure mask for permitting exposure irradiation only in a predetermined area is provided in order to effect patterning.

Further, such a method wherein ai projection mold plate is heated and pressed against the substrate so that only the projection portion contacts the substrate to color only the contact portion is also effective.

Further, this method is also applicable to prepare a multi-color display device. For example, it is possible to change the color of the tinting colorant to be colored depending on areas by changing, e.g., an exposure wavelength. Alternatively, such a method wherein a sensitivity to the external stimulus is changed by adding an assistant, such as a sensitizing colorant or an infrared absorption colorant, to the tinting colorant, is also effective. In these cases, it is essential that the external stimulus, the tinting colorant and the order of external stimulus irradiation are optimized so as not to color an area, which has been once colored by an external stimulus (or not colored by shielding), by irradiation of another external stimulus.

The sequential irradiation method (2) may be a known method such that an irradiation portion is limited to an area which is not larger than a planar display area of the display surface, and the limited area is irradiated with the external stimulus while being sequentially shifted. The size of the limited are to be irradiated with the external stimulus is not particularly restricted but may preferably be not less than a pixel size, more preferably be not less than each microcapsule or cell in the display device. The irradiation with the external stimulus may be controlled by, e.g., a method wherein a shielding member is placed or not placed between an external stimulus generating source and the display surface, or a method wherein an external stimulus is generated by a pulse signal and the pulse signal is subjected to on-off control. The latter method is preferably used.

Incidentally, in the present invention, it is not necessary to actuate (drive) the electrophoretic particles during the irradiation of external stimulus. In the case of actuating the electrophoretic particles the electrophoretic particles may be actuated regularly or irregularly. In the case of not actuating the electrophoretic particles, the electrophoretic particles may be concentrated at a certain portion of the microcapsule or cell or dispersed uniformly in the microcapsule or cell. In order to effectively performing the external stimulus irradiation, the electrophoretic particles may preferably be regularly actuated in the case of actuating the electrophoretic particles and be concentrated at a certain portion of the microcapsule or cell in the case of not actuating the electrophoretic particles.

After the above steps, the entire display apparatus may preferably be protected or covered with such a substance through which the external stimulus passes, so as to avoid coloring of the optical modulation member for the display apparatus. Examples of the substance may include a thermal protective agent, an ultraviolet (UV) absorber, etc. These are appropriately selected depending on the tinting colorant used.

Hereinbelow, the present invention will be specifically described based on Examples.

### EXAMPLE 1

As a tinting colorant, a solution was prepared by dissolving 0.1 g of crystal violet lactone (“CVL”, mfd. by Yamamoto Kasei K.K.) and 0.1 g of a phenolic developer (“ADEKA ARKLS K-5”, mfd. by Asahi Denka Kogyo K.K.) in 10 g of diisopropylnaphthalene and then dissolving therein 10 g of “Takenate D-110N” (mfd. by Takeda Chemical Industries, Ltd.).

The resultant solution was mixed in 20 g of a 3%-aqueous solution of polyvinyl alcohol (“PVA-110”, mfd. by Kuraray Co., Ltd.) and were then emulsified by a homomixer (“HF-93”, mfd. by TITEC Co.). The resultant emulsion was stirred or 3 hours at 40° C. to effect encapsulation reaction. The resultant liquid was subjected to precipitation by a cooling centrifugal separator (“GRX-220”, mfd. by K.K. Tommy Seiko) and decantation, followed by three washing cycles wherein the precipitate was dispersed again by adding water and was reprecipitated by the centrifugal separator. Thereafter, the resultant precipitate was dried to obtain microcapsules (1) containing the tinting colorant. The microcapsules had a particle size of Ca. 1 μm by controlling the reaction condition or subjecting the microcapsules to classification.

Next, microcapsules containing electrophoretic particles, a dispersion medium and so on were prepared in the following manner.

Isoper M (mfd. by Exxon Mobil Corp.) was used as the dispersion medium, and titanium oxide (“Tiprue R-104”, mfd. by Dupont Co.) was used as white electrophoretic particles. The white electrophoretic particles, a surfactant (“OLOA 1200”, Oronite Japan K.K.), and the microcapsules (1) represented above were mixed in the dispersion medium (Isoper M) in amounts of 10 wt. %, 0.5 wt. %, and 15 wt. %, respectively. The resultant mixture was added into a protective colloid aqueous solution and emulsified by stirring. To the resultant emulsion, sodium carbonate was added to adjust the pH value to 9 and then a prepolymer of urea-formaldehyde was added, followed by addition of acetic acid to adjust the pH value to 5. The resultant mixture was reacted by 2 hours at 60° C. to polymerize the prepolymer, thus forming a film of urea resin as a well of microcapsule to obtain a slurry of microcapsules (2) having a particle size of 100 μm. The particle size was given by adjusting emulsifying condition and classifying the microcapsules so as to have a particle size range of 90-110 μm. Thereafter, 10 wt. %-dispersion of the microcapsule (2) was prepared by adding water to the microcapsule (2).

Then, on a 1 mm-thick glass substrate, ca. 0.2 μm-thick Al layer as a first electrode was formed in a pattern. On the resultant substrate, the dispersion of the microcapsules (2) was spread by a blade coater, followed by drying to form a microcapsule layer.

A substrate of a PET film (200 μm in thickness) provided with a ca. 0.1 μm-thick ITO film as a second electrode was hermetically adhered for sealing to the above-prepared substrate, and a voltage application mean was provided, thus preparing an electrophoretic display.

The electrophoretic display was heated for 20 seconds at 120° C. by a thermal gradient tester (“HG-100”, mfd. by Toyo Seiki K.K.) while being supplied with an AC voltage (1 Hz, 100 V). As a result, only at the heated portion, it was confirmed that CVL (tinting colorant) caused color development of blue from a colorless state. In such a state, when a color difference of the change in color was measured by a color difference meter (“Colour-guide 45/0”; light source: D65; viewing angle: 10 degrees; mfd. by Gardner Co.), the color difference value was 37.5.

Further, as a result of drive of the electrophoretic display by applying a voltage between the upper and lower electrodes, it was possible to provide the electrophoretic display with a good blue-white display state only at the heated portion. In addition, the electrophoretic display showed a high contrast of 6.3.

### EXAMPLE 2

An Al-patterned substrate was prepared in the same manner as in Example 1. On the substrate, a white scattering layer as an insulating film was formed by spin-coating a dispersion of titanium oxide in a thermosetting resin (“OPTMER”, mfd. by JSR K.K.) and heat-curing the resin. Thereafter, on the insulating layer, titanium was vapor-deposited and a black photoresist was applied, followed by patterning in a predetermined shape through a photolithographic process to prepare a second electrode. The thermosetting resin was again spin-coated so as to cover the second electrode and the insulating layer to form an insulating layer. Onto the entire resultant surface, a photosensitive epoxy resin was applied and formed in a partition wall so as to have a width of 7 μm and a height of 15 μm between adjacent display pixels by the photolithographic process.

Polystyrene particles (“HIMER ST95”, mfd. by Sanyo Kasei Kogyo K.K.), a functional near-infrared absorption colorant (“IR820B”, mfd. by Showa Denko K.K.) and tetrabutylammonium butyltriphenyl borate were dissolved in acetone. The solution was added dropwise in hexane under stirring to precipitate polystyrene particles, followed by filtration and drying to prepare polystyrene particles containing the functional infrared absorption colorant. Speeds of dropwise addition and stirring were controlled to provide the polystyrene particles with an average particle size of 1 μm.

Then, an electrophoretic liquid containing electrophoretic particles, a dispersion medium and so on was prepared in the following manner.

Isoper M (mfd. by Exxon Mobil Corp.) was used as the dispersion medium, and polystyrene particles identical to those described above were used as electrophoretic particles. The electrophoretic particles and a surfactant (“OLOA 1200”, Oronite Japan K.K.) were mixed in the dispersion medium (Isoper M) in amounts of 10 wt. % and 0.5 wt. %, respectively.

After the electrophoretic liquid was filled in the above-prepared substrate, a PET film (100 μm in thickness) was hermetically adhered for sealing to the above-prepared substrate, and a voltage application mean was provided, thus preparing an electrophoretic display.

Then, by using a semiconductor laser (wavelength: 840 nm; output: 4 mV), exposure was performed in such a manner that the display panel was sequentially scanned characterwise so as to correspond to the electrodes and pixels. As a result, only the exposed portion was decolorized (changed in color) from a blue state to a colorless state. Thereafter, onto the display surface of the display panel, a near-infrared reflection sheet was applied.

As a result of drive of the thus-prepared electrophoretic display by applying a voltage between the upper and lower electrodes, it was possible to provide the electrophoretic display with a good blue-white display state in correspondence with pixel. In addition, the electrophoretic display showed a high contrast.

### EXAMPLE 3

A solution for a color filter layer containing photosensitive tinting colorants was prepared.

Spiropyran and zinc chloride were dissolved in a small amount of ethanol, whereby a photosensitive agent (zinc oxide 3,3′-dimethyl-6′-nitro-spiro compex) sensitive to blue (B) light was formed in a state of ring-opened spiropyran to which metal was connected. Then, in the resultant solution, PVA (polyvinyl alcohol) (“PVA-103”, mfd. by Kuraray Co., Ltd.) was dissolved. Similarly, a solution of a photosensitive agent (cobalt chloride 1,3-dimethyl-3-isopropyl-6′-nitro-spiro complex) which was sensitive to green (G) light and in which PVA was dissolved, and a solution of a photosensitive agent (barium naphthenate, 1,3,3-trimethyl-nitro-spiro complex) which was sensitive to red (R) light and in which PVA was dissolved, were prepared, respectively. Thereafter, these three solutions were mixed in equal proportions to prepare a color filter layer forming solution.

An Al-patterned substrate was prepared in the same manner as in Example 1.

Then, microcapsules were prepared in the following manner.

The microcapsules were prepared in the same manner as in Example 1 except that the microcapsules (1) was changed to a mixture of titanium black (“13M-T, mfd. by Mitsubishi Kagaku K.K.) as black electrophoretic particles with titanium oxide (1:1 by weight). A microcapsule dispersion was prepared by adding 10 wt. % of the microcapsules in water, and was spread on the substrate by a blade coater to form a microcapsule layer.

Thereafter, onto a PET substrate (100 μm in thickness) provided with a ca. 0.1 μm-thick vapor deposited ITO film, the color filter layer forming solution prepared above was applied by spin coating, followed by drying to obtain the PET substrate provided with a color filter layer.

The PET substrate and the substrate provided with the microcapsule layer were hermetically adhered for sealing to each other, and a voltage application means was provided thereto, thus preparing an electrophoretic display.

Then, the color filter layer of the display panel of the electrophoretic display was subjected to exposure with a LED array including light sources of red (R), green (G) and blue (B) by controlling respective multi-color signals so that an arbitrary area of color selected from the three colors through Selfoc lens corresponds to an associated pixel area.

The thus prepared electrophoretic display was driven by applying a voltage between the upper and lower electrodes, so that the electrophoretic display provided a good display state between black and arbitrary one color which was selected from three colors (R, G, B), and exhibited a good contrast.

### EXAMPLE 4

An electrophoretic display was prepared in the same manner as in Example 1 except that in the coloring step of the tinting colorant, heating with the thermal gradient tester was changed to heating for 1 minute with a 600 W far-infrared heater in a state that a white-black photomask was placed on the display panel surface.

As a result of the heating, color development of blue from a colorless state was confirmed at a portion corresponding to the black photomask portion. Further, as a result of drive of the electrophoretic display by applying a voltage between the upper and lower electrodes, the electrophoretic display provided a good blue-white display state only at the black photomask portion. In such a state, when a color difference and a contrast were measured in the same manner as in Example 1, the color different value was 32.3, and the contrast value was 6.1.

### EXAMPLE 5

Polystyrene particles (“HIMER ST95”, mfd. by Sanyo Kasei Kogyo K.K.), 0.1 g of 3-dibutylamino-7-(o-chlorophenyl)aminofluoran as a tinting colorant, and 0.3 g of octadecylphosphonic acid as a color developer were dissolved in toluene. The resultant solution was added dropwise in hexane under stirring to precipitate a polystyrene crystal, which was filtered and dried to provide polystyrene particles containing the tinting colorant. In this step, speeds of dropwise addition and stirring were adjusted and classification was performed so as to provide an average particle size of 1 μm.

An Al-patterned substrate was prepared in the same manner as in Example 2 except that patterning is performed so that all the pixels at the display surface were actuated by a single electrode.

An electrophoretic liquid was prepared by mixing 10 wt. % of the polystyrene particles prepared above and 0.5 wt. % of a surfactant (“OLOA 1200”, mfd. by Oronite Japan K.K.) in a dispersion medium (“Isoper M”, Exxon Mobil Corp.).

The electrophoretic liquid was filled in the Al-patterned substrate, to which a PET film (100 μm in thickness) was hermetically adhered for sealing, and a voltage application means was provided thereto to prepare an electrophoretic display.

Then, by using an apparatus including a thermal dot printer as a rewriting unit, printing was performed on the display panel of the electrophoretic display. As a result, the electrophoretic particles at the printed portion was changed from a colorless state to a black state.

When the electrophoretic display was driven by applying a voltage between the electrodes, the electrophoretic display provided a good black-white display state corresponding to a printing pattern.

Then, when the electrophoretic display was left standing for 5 minutes in a constant temperature oven which was temperature-controlled to 100° C. and was cooled gradually, it was confirmed that all the electrophoretic particles were decolored to be placed in a colorless state, and the entire display panel assumed white.

Further, by using the above-mentioned rewriting unit, printing was performed in another printing pattern on the display panel of the electrophoretic display. As a result, the electrophoretic particles at the printed portion was changed from a colorless state to a black state. Further, as a result of drive of the electrophoretic display under application of a voltage, the electrophoretic display provided a good black-white display state corresponding to the printing pattern.

According to this example, it was possible to provide the electrophoretic display capable of effecting rewriting operation any (desired) number of times.

As described hereinabove, by using the production process of electrophoretic display according to the present invention, it is possible to simply effect color arrangement at a predetermined position. As a result, it becomes possible to perform a simple positional alignment of a device particularly using microcapsules, which has been conventionally difficult, and production steps of the device can be facilitated.

While the invention has been described with reference to the structures disclosed herein, it is not confined to the details set forth and this application is intended to cover such modifications or changes as may come within the purposes of the improvements or the scope of the following claims.

What is claimed is:

1. An electrophoretic display, comprising:
a substrate, and
at least one pixel disposed thereon comprising electrophoretic particles and a dispersion medium or comprising the electrophoretic particles, the dispersion medium and a color filter layer,
wherein at least one of the electrophoretic particles, the dispersion medium and the color filter layer constituting each pixel has a property of being colored a predetermined color by an external stimulus and said one of the electrophoretic particles, the dispersion medium and the color filter layer is changeable into a colored member by the external stimulus.

2. A display according to claim 1, wherein the colored member is at least one of the electrophoretic particles, the dispersion medium, and the color filter layer.

3. A display according to claim 1, wherein the colored member contains a dye which is colored by at least the external stimulus.

4. A display according to claim 3, wherein the dye is encapsulated in a microcapsule.

5. A display according to claim 3, wherein the dye has a property of assuming a plurality of different colors by at least one species of external stimulus.

6. A process for producing an electrophoretic display of the type wherein at least one pixel comprising electrophoretic particles and a dispersion medium or comprising the electrophoretic particles, the dispersion medium, a color filter layer is disposed on a substrate, said process comprising:
a step of providing a member, to be colored in a predetermined color by an external stimulus, as at least a part of members constituting said at least one pixel, and
a step of coloring the member to be colored by applying the external stimulus to the member.

7. A process according to claim 6, wherein the member to be colored is at least one of the electrophoretic particles, the dispersion medium, and the color filter layer.

8. A process according to claim 6, wherein said process further comprises a step of spatially sealing hermetically the electrophoretic particles and the dispersion medium.

9. A process according to claim 8, wherein the coloring step is performed after the hermetically sealing step.

10. A process according to claim 6, wherein the external stimulus is selected from the group consisting of thermal energy, light energy, electron ray, γ ray, and X ray.

11. A process according to claim 6, wherein said at least one pixel is a plurality of pixels.

12. A process according to claim 11, wherein a part of the plurality of pixels are shielded, and a remaining part of the plurality of pixels are supplied with the external stimulus.

13. A process according to claim 6, wherein the external stimulus is applied in a state that the electrophoretic particles and the dispersion medium are encapsulated in a microcapsule.
